(19) United States
(12) Patent Application Publication
(10) Pub. No.: US 2004/0244032 A1
(43) Pub. Date: Dec. 2, 2004

(54) Receiving apparatus, communication apparatus, receiving system and receiving method

(75) Inventor: Masahiro Yamada, Nishitama-gun (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/805,538

(22) Filed: Mar. 22, 2004

(30) Foreign Application Priority Data
Apr. 25, 2003 (JP) 2003-122518

(51) Int. Cl. H04N 7/16

(52) U.S. Cl. 725/25; 379/93.02; 455/3.01

(57) ABSTRACT

A receiving apparatus comprises a receiving unit which receives a contents signal from a broadcast station in accordance with the result of authentication processing executed with the broadcast station, a registration unit which executes communication with an external communication device, and sets and registers an ID in a range of a predetermined number, and a communication unit which executes authentication processing with an external device using the ID and transmits the contents of the contents signal to the external device in accordance with the result of the authentication. A communication apparatus connected to the receiving apparatus through a network in a home is managed using a family ID thereby to protect the copyright of the contents of a fee-charging broadcast service or the like.

### CROSS-REFERENCE TO RELATED APPLICATIONS

This application is based upon and claims the benefit of priority from prior Japanese Patent Application No. 2003-122518, filed Apr. 25, 2003, the entire contents of which are incorporated herein by reference.

### BACKGROUND OF THE INVENTION

1. Field of the Invention

The present invention relates to a receiving apparatus for receiving a fee-charging broadcast service and a communication apparatus supplied with the contents information, etc. of the fee-charging broadcast service through the receiving apparatus and a network such as LAN, in which an ID is registered and managed effectively in the network.

2. Description of the Related Art

With the recent extension of the digital network technique, a system has come to be utilized in which the contents of the fee-charging broadcast service, etc. can be recorded and reproduced under a predetermined level of protection.

An example of the prior art related to this technique is an information distribution control method disclosed in Jpn. Pat. Appln. KOKAI Publication No. 2002-73861, wherein the distribution information is acquired through a distribution server and then distributed to each terminal through a network.

In this conventional system, a terminal is set arbitrarily on the network, and a user ID of the terminal owner is set at this terminal.

In the information distribution control system described above, however, although a terminal can be arbitrarily set on the network, the terminal which can be set is not specifically limited. This leads to the inconvenience described below, in a system comprising a receiver (server) of a fee-charging broadcast service or the like and a communication device (terminal) to which the contents information or the like of the broadcast program is distributed from the receiver. Specifically, a malicious user owning a receiver may distribute the user ID of a communication device (terminal) capable of receiving the contents of the receiver to many other users and limitlessly sets the ID for the communication devices, so that many communication devices may be connected to the receiver through the Internet or the like and thereby the contents of the fee-charging broadcast service to a great number of communication devices. As long as the conventional information distribution system is used maliciously this way, the copyright of the contents of the fee-charging broadcast service cannot be fully protected.

Another problem is that in the case where an ID, if embedded in a communication device, cannot be used any longer in the case where the communication device or the receiver is repurchased.

### BRIEF SUMMARY OF THE INVENTION

According to an aspect of the present invention, there is to provided a receiving apparatus comprising: a receiving unit which executes authentication processing with a distributor and receives a contents signal from the distributor in accordance with the authentication result; a registration unit which sets and registers an ID for communication with an external communication device in the case where the number of times the ID is set or the total number of the communication devices for which the ID is set is not more than a predetermined number; and a communication unit which executes authentication processing with the external unit using the ID registered in the registration unit and transmits to the communication device the contents signal received by the receiving unit in accordance with the authentication result.

### BRIEF DESCRIPTION OF THE SEVERAL VIEWS OF THE DRAWING

FIG. 1 is a diagram for explaining the concept of a receiving system according to an embodiment of the present invention.

FIG. 2 is a block diagram showing an example of a receiving apparatus according to the embodiment of the invention.

FIG. 3 is a diagram for explaining an example of the process of registering a family ID for the receiving system according to the embodiment of the invention.

FIG. 4 is a diagram for explaining an example of the process of transmitting the contents for the receiving system according to the embodiment of the invention.

FIG. 5 is a diagram for explaining an example of the process of receiving the family ID for the receiving system according to the embodiment of the invention.

FIG. 6 is a diagram for explaining an example of addition of a new receiving apparatus in the receiving system according to the embodiment of the invention.

FIG. 7 is a diagram for explaining an example of addition of a new receiving apparatus in the receiving system according to the embodiment of the invention.

FIG. 8 is a diagram for explaining an example of addition of a new receiving apparatus in the receiving system according to the embodiment of the invention.

FIG. 9 is a diagram for explaining an example of addition of a new receiving apparatus in the receiving system according to the embodiment of the invention.

FIG. 10 is a diagram for explaining an example of addition of a new receiving apparatus in the receiving system according to the embodiment of the invention.

FIG. 11 is a diagram for explaining an example of addition of a new receiving apparatus in the receiving system according to the embodiment of the invention.

FIG. 12 is a diagram for explaining an example of addition of a new receiving apparatus in the receiving system according to the embodiment of the invention.

FIG. 13 is a diagram for explaining an example of addition of a new receiving apparatus in the receiving system according to the embodiment of the invention.

FIG. 14 is a diagram for explaining the receipt of an ID for a plurality of receiving apparatuses in the receiving system according to the embodiment of the invention.

FIG. 15 is a block diagram showing an example of a recorder/player for the receiving system according to the embodiment of the invention.

FIG. 16 is a flowchart showing the process of registering the family ID for the receiving system according to the embodiment of the invention.

FIG. 17 is a flowchart showing the process of registering the family ID for the receiving system according to the embodiment of the invention.

FIG. 18 is a flowchart showing the process of registering the family ID for the receiving system according to the embodiment of the invention.

FIG. 19 is a flowchart showing the process of registering the family ID for the receiving system according to the embodiment of the invention.

FIG. 20 is a flowchart showing the process of communication using the family ID for the receiving system according to the embodiment of the invention.

FIG. 21 is a flowchart showing the process of communication using the family ID for the receiving system according to the embodiment of the invention.

FIG. 22 is a flowchart showing the process of communication using the family ID for the receiving system according to the embodiment of the invention.

FIG. 23 is a flowchart showing the process of canceling the family ID for the receiving system according to the embodiment of the invention.

### DETAILED DESCRIPTION OF THE INVENTION

A receiving apparatus, a communication apparatus and a receiving system according to an embodiment of the invention will be explained in detail below with reference to the accompanying drawings. [Receiving apparatus and communication apparatus according to the invention]

(Introduction)

The receiving apparatus according to this invention is, for example, a digital TV having built therein an HDD (hard disk drive), wherein with a title recorded in the HDD, the contents of a fee-charging broadcast service, for example, can be duplicated and transmitted simply by those devices (devices meeting the accessibility guide) recorded and connected through a network which are used within a limited range such as a home.

The recording media used are not specifically limited and include a fixed or removable HDD, DVD or SD card.

The “limited range” is defined under the contract with a broadcast business establishment.

The “devices used within a limited range” include the devices covered by the contract with the broadcast station and other devices connected to such devices.

The receiving system is the one for duplicating and transmitting the contents in such a form that the copyright is protected.

(Terms)

The terms used in the receiving apparatus, the communication apparatus, the receiving system and the receiving method according to this invention are defined as follows:

The “broadcast station” is a collective terms indicating all parties supplying the contents to receivers and includes the broadcast business trustor, the broadcast business trustee, the contents copyright owner, the contents provider and the internet provider.

The “receiver” is defined as, for example, a digital broadcast receiver STB (set top box). This receiver has a limited receiving function and operates under the receiving contract with a broadcast station. Nevertheless, the receiving operation is not necessarily by broadcasting but may be through the internet as long as the receiving function is limited.

The receiver may have the storage function and operate as a home server by storing the received contents. The storage function may be implemented either by incorporating a recording device such as HDD in the receiver or by external connection. In the case where the storage function is lacking, the contents are output to a recorder/player or the like as soon as received. Also, the receiver may be provided as a receiving function to be built in a digital TV connected with the HDD.

The “recorder/player”, which may have no function of receiving the broadcast signal directly, is defined as a device, for example, to record and reproduce the contents received by the receiver connected by a network or the like and preferably assumes the form of a mobile player, as an example. Preferably, however, the recorder/player is a communication equipment having wider functions including at least communication and authentication, and a display unit such as a liquid crystal display. Further, the recorder/player preferably has the function of encrypting and decrypting the contents and an interface for supplying the audio-visual information to an external TV set.

The “family ID” is an ID number assigned to each home by the broadcast station for identification of the particular home, and basically varies from one receiver to another. In the case where a single home has a plurality of receivers, however, the same family ID is preferably assigned to the plurality of receivers.

The “Kdev (Kdevice)” is a device key of 56 bits long, for example, which value is different for a different set device. A licensing mechanism such as DTCP (digital transmission content protocol) assigns a unique key to each receiver and each recorder/player maker.

(Concept of Home Device: Transmission and Reception of Contents in a Home)

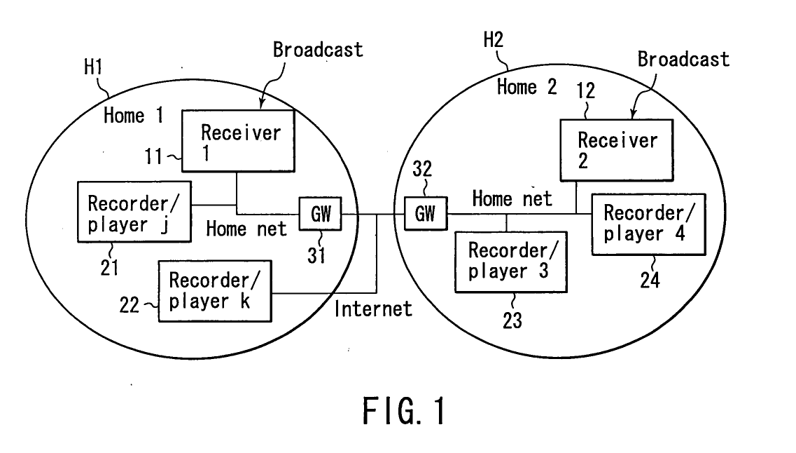

FIG. 1 is a diagram for explaining the concept of a receiving system according to an embodiment of the invention. With reference to FIG. 1, the operation of a receiving apparatus (receiver) and a communication apparatus (recorder/player) for transmitting and receiving contents according to this invention is explained below.

As shown in FIG. 1, a home H1 (H2) owns a receiver 11 (12) having the server-like function of receiving and storing the broadcast contents. Specifically, the home H1 has the receiver 11, and the different home H2 has the receiver 12. The contents are received and stored by the receivers 11 and 12 independently of each other. Each receiver holds a receiving contract with the broadcast station and is considered to constitute one home unit.

Basically, the contents are acquired from outside the home by the receiver 11 and transmitted to and received from the home devices by copying or the like. The home devices include recorder/players 21, 22 (23, 24), which receive the contents not directly from the broadcast station but reproduce the contents received from the receiver constituting the server.

The devices capable of transmitting and receiving the contents to and from the receiver 11 are the recorder/players 21, 22, and the devices capable of transmitting and receiving the contents to and from the receiver 12 are the recorder/players 23, 24. The receiver 11 and the recorder/players 21, 22 are defined as one home device group making up a family H1, and the receiver 12 and the recorder/players 23, 24 are defined as another home group making up a family H2. Except in the case where the same home has two or more receivers, one recorder/player 23, for example, is never associated with both the receivers 11 and 12 as a family at the same time. Therefore, the contents received by a receiver 11n and not permitted to be copied outside the home can never be copied to the devices of the family H2.

The devices of each family have the same family ID, and the contents can be permitted to be copied between the devices of the same family ID within the home. The contents can thus be copied between the devices having the same family ID regardless of whether the devices are connected by the Internet or not. The contents can be downloaded from the server in the home to a portable terminal, for example, such as wireless LAN outside the home. A family is not defined as a network space limited by a gateway and/or a router but as a group of devices having the same family ID.

(Receiving and Recording Process)

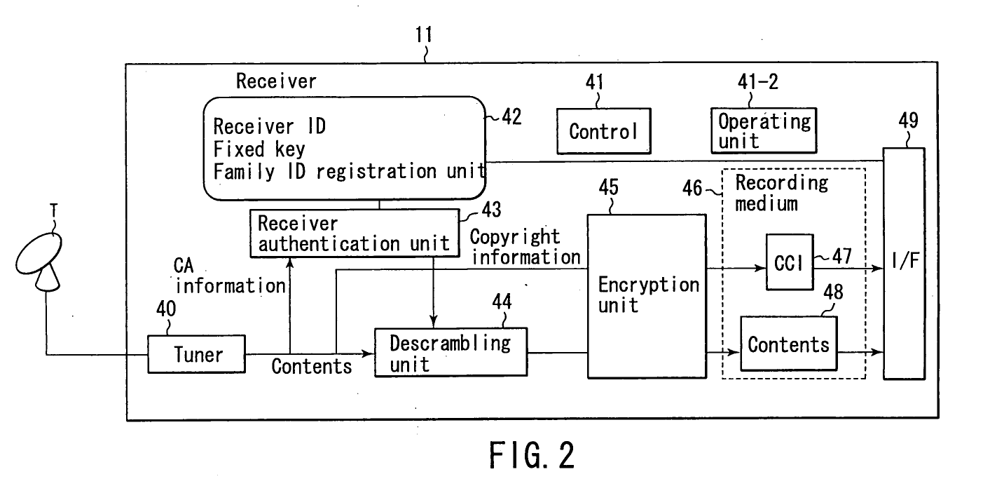

FIG. 2 is block diagram showing an example of a receiving apparatus according to the embodiment of the invention. In FIG. 2, the receiving apparatus 11 according to the embodiment of the invention includes a tuner 40 for receiving the broadcast signal from an external antenna T and a descrambling unit 44 for decoding the contents encrypted. Further, the receiving apparatus 11 includes a receiver authentication unit 43 for, in response to the output from a tuner 40, authenticating the receiver 11 on behalf of, for example, a broadcast station (or a provider on a network) acting as a distributor and a registration unit 42 for registering a receiver ID, a unique key and a family ID.

The receiving apparatus 11 further includes the descrambling unit 44 as described above, which is supplied with the contents signal of the tuner 40 and a transmission cipher descramble key Ks of the receiver authentication unit 43 and subjected to the descrambling process, an encryption processing unit 45 for encrypting the descrambled contents information and copyright information, and a recording medium 46 for storing the encrypted contents information 48 and CCI (copy control information) 47. Further, the receiving apparatus 11 according to the invention includes a control unit 41 for controlling the overall operation, an operating unit 41-2 such as an operating panel, and an I/F unit 49 making up a communication unit for carrying out communication with external devices.

In the receiver 11 having this configuration, the broadcast signal supplied from the antenna T is tuned by the tuner 40 and demodulated into the received broadcast data. From this received broadcast data, the limited received information encrypted for the receiver is extracted and decoded by a unique key held by the receiver thereby to retrieve the transmission cipher key Ks and the family ID information. The same family ID may be assigned to different receivers if permitted by the broadcast station.

Next, the transmission cipher descramble key Ks is supplied to the descrambling unit 44 thereby to descramble the received contents. The descrambled contents are encrypted by the encryption processing unit 45 and recorded in the recording medium 46. At this time point, the recorded contents can be reproduced only by the device that has received the broadcast signal directly. As an alternative, the recorded contents are read appropriately, and through the I/F unit 49, supplied to an external recorder/player or a TV set (not shown) and reproduced as an image.

(Communication Apparatus: Recorder/Player)

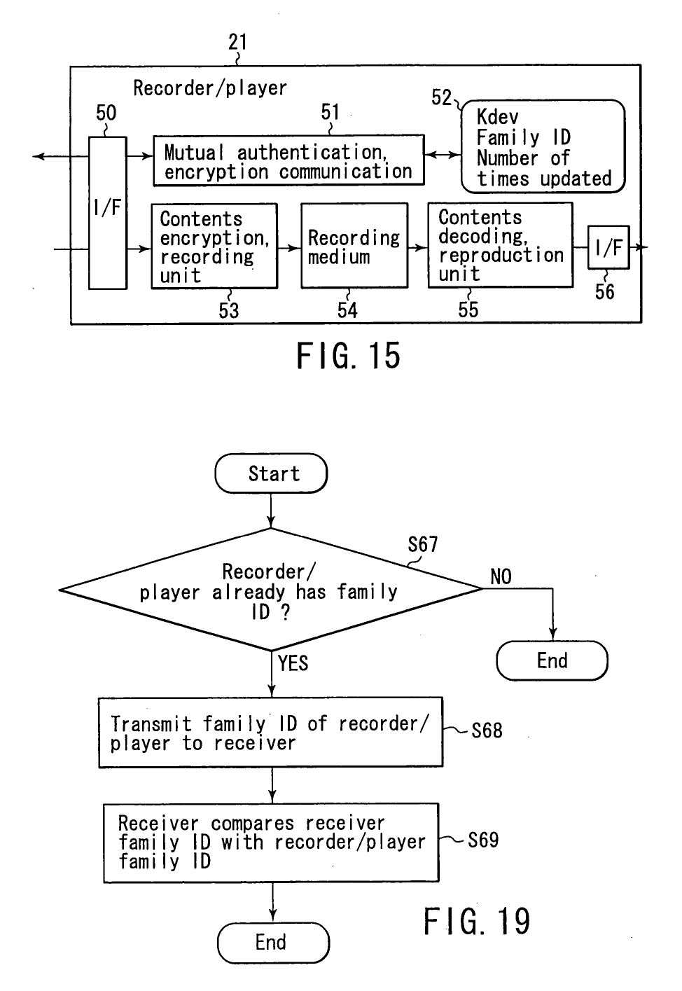

A configuration of a recorder/player providing an example of a communication apparatus will be explained with reference to FIG. 15. FIG. 15 is a block diagram showing an example of a recorder/player in the receiving system according to the embodiment of the invention.

The recorder/player 21 includes an I/F unit 50 making up a communication interface of a wire LAN (local area network) or a wireless LAN, a mutual authentication and cipher communication unit 51 connected to the I/F unit 50, and a memory 52 connected to the mutual authentication and cipher communication unit 51 for storing the device key Kdev, the family ID information, the update number-of-times information and the like. The recorder/player 21 further includes a contents encryption and recording unit 53 connected to the I/F unit 50, a recording medium 54 such as HDD for recording the encrypted contents, a contents decryption and reproduction unit 55 for decrypting and reproducing the contents, etc. read from the recording medium 54, and an I/F unit 56 such as a communication interface or an output terminal for outputting the contents information to, for example, an external TV set.

As described above, the recorder/player 21 has no function of receiving the broadcast signal or the like directly, but by being connected to the receiver through a network, records and reproduces the contents received by the receiver. Further, the recorder/player 21, whose functions are not limited to those described above, is preferably a communication apparatus further having at least the functions of communication and authentication, and a display unit such as a liquid crystal display.

(Family Registration of Recorder/Player in Receiver)

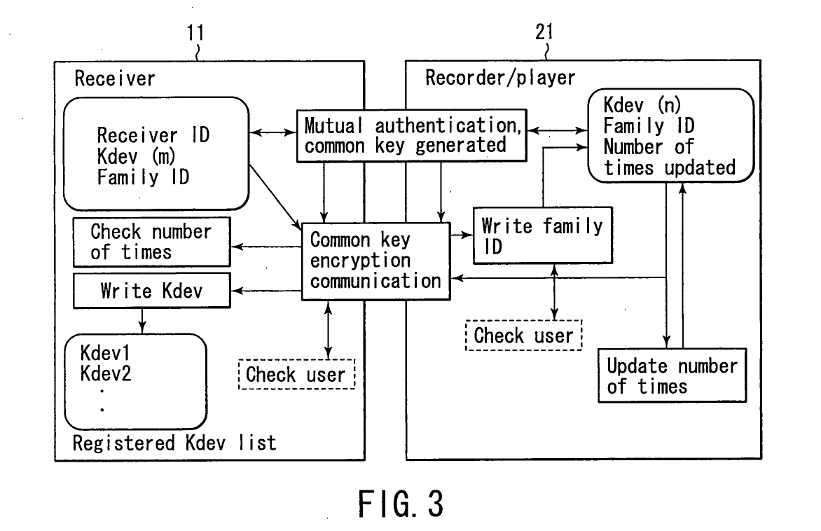

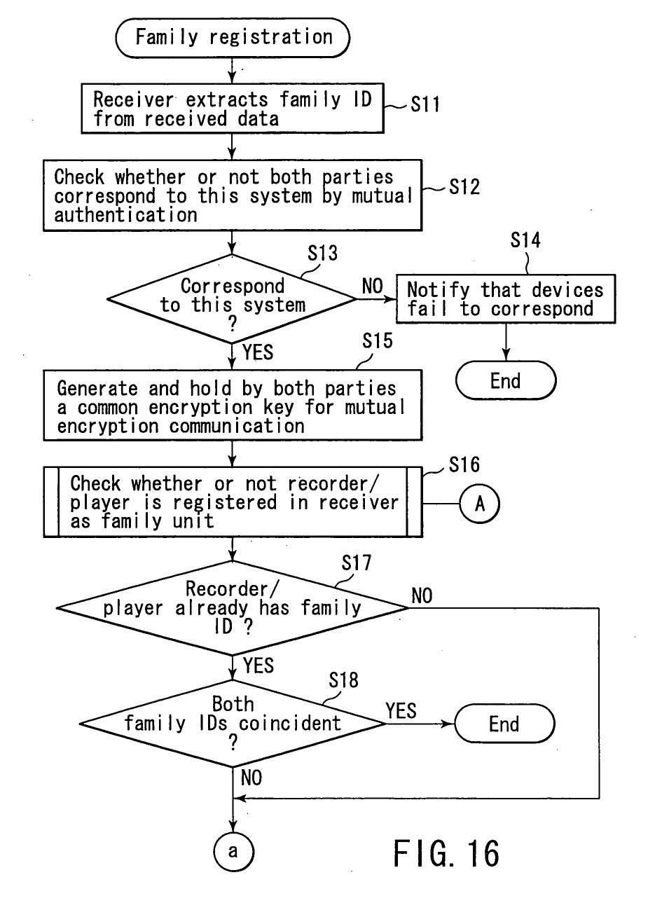

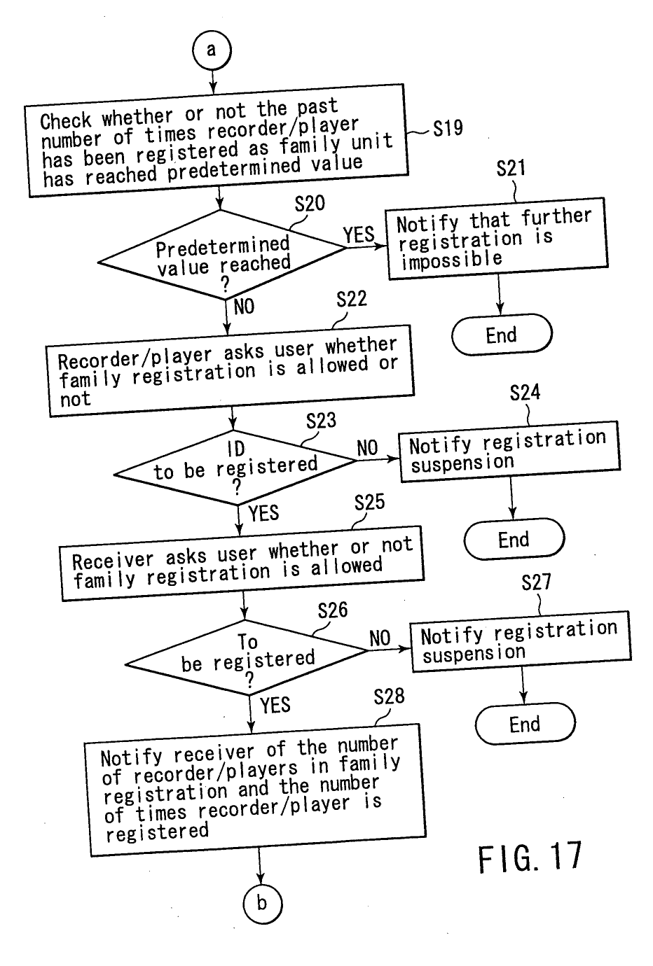

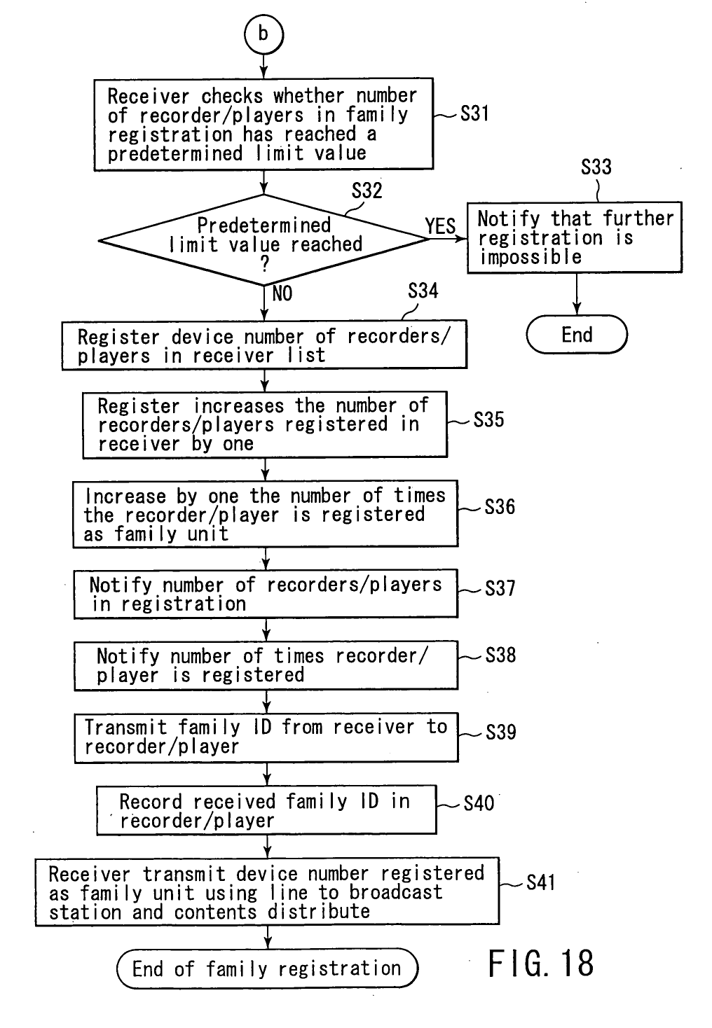

Next, the family registration constituting one of the features of this invention will be explained in detail with reference to the drawings. FIG. 3 is a diagram for explaining an example of the process for registering the family ID in the receiving system according to the embodiment of the invention. FIGS. 16 to 19 are flowcharts showing the family ID registration process in the receiving system according to the embodiment of the invention.

Several recorder/players 21 connected with the receiver 11 for receiving the contents are registered as family devices in the receiver 11. This process is called the family registration, whereby the particular recorder/players are regarded to exist in the same home as the receiver 11. The family registration of each recorder/player 21 may be carried out at the time point when the recorder/player 21 is connected to the receiver 11, or preferably, the family registration is normally conducted at the time of transmitting or receiving the contents permitted to be distributed only in a home. Thereafter, the transmission and reception and duplication of the received broadcast contents, which have thus far been impossible among the devices connected to the Internet or the like having a limitless range, becomes possible among the devices determined to exist in the same home.

The procedures of the family registration are explained in detail. First, in FIGS. 3 and 16, the receiver 11 acquires the family ID (identification) information from the received data supplied as a broadcast signal from a broadcast station or the like distributor (S11). However, this ID information for family registration is not necessarily supplied as a part of the broadcast signal from a broadcast station, but may be supplied in the form incorporated in the receiver 11 at the time of factory shipment. As another alternative, the ID information may be supplied from the distributor, for example, through the Internet or the like connected to the interface unit 49 shown in FIG. 2.

Next, the receiver 11 and the recorder/player 21, in order to check whether or not they mutually correspond to this CP (call processing) system, authenticates each other by a challenge and response system using random numbers (S12). In the case where the two parties fail to correspond to this CP system, the fact is indicated to the user and the process is terminated (S14). In the case where the two parties correspond to this CP system, on the other hand, a common key is generated based on random numbers and held by both parties (S15). After that, the communication between the receiver and the recorder/player is conducted by the common key encryption communication using the particular key.

Then, it is checked whether or not the family registration has already been completed between the receiver 11 and the recorder/player 21 (S16). Specifically as shown in the flowchart of FIG. 19, it is determined whether or not the recorder/player 21 has already a family ID (S67). In the case where the recorder/player 21 already has a family ID, the family ID of the recorder/player 21 is transferred to the receiver 11 (S68). The receiver 11 compares the family ID of the receiver 11 with that of the recorder/player 21 (S69).

Specifically, as long as the recorder/player 21 has a family ID (S17) and the family IDs of the two parties are coincident with each other, no family ID is required to be newly issued and registered. Thus, the process is terminated (S18). In the case where the family IDs of the two parties fail to coincide with each other and the recorder/player 21 has yet to be registered as a family unit, on the other hand, the process proceeds to the next step.

Next, the recorder/player 21 notifies the receiver 11 of the number of times the family ID register of the recorder/player 21 has been updated. The receiver 11 compares the number of times the family ID of the recorder/player 21 is updated, with a predetermined value-(family ID updated number-of-times limit value) (S19). In the case where the number of times the family ID is updated reaches the predetermined value (S20), the indication is made to the user to the effect that no further registration is possible (S21). The number of times the family ID is updated is set to 0 at the time of factory shipment. In the case where, for example, the limit value is 5 and the current number of times updated is 4, the family registration can be made for one more different receiver. Preferably, the process of comparing the number of times the family ID of the recorder/player is updated with a predetermined value (limit value) is preferably executed by the recorder/player 21 and the result of comparison is transmitted from the recorder/player 21 to the receiver 11.

When the predetermined value (family ID updated number-of-times limit value) is not reached, on the other hand, the recorder/player 21 requests the user, by a GUI (graphical user interface) or the like, whether the family ID is to be registered or not (S22). When no response is received to register the family ID (S23), the suspension of the registration is notified (indicated) to the user (S24). When a response is received to register the family ID, on the other hand, the process proceeds to the next step.

An upper limit is set to the number of times the family ID is rewritten by reason of the fact that in the absence of this limit, the user could change the receiver for family registration of the recorder/player in disorderly manner each time the contents are downloaded, with the result that the contents could be transmitted to or received from substantially none of the receivers and the recorder/players. By setting an upper limit of the number of times the family ID can be rewritten, the disorderly family registration is prevented, and therefore a fixed internal range of a home can be generated.

Further, the user is prompted to check, by GUI or the like, whether or not the family registration of the recorder/player 21 is made in the receiver 11 as a device of the same home (S25). In this case, the operation of obtaining the user approval from the operating unit 41-2 of the receiver 11 is made essential. It is thus possible to prevent an illegal act such as an unlawful intrusion into the receiving apparatus of a third party from a remote place through the internet, for example, and register the family ID in the recorder/player 21 constituting the local communication apparatus.

In the absence of a response to register the family ID (S26), the suspension of registration is notified (indicated) to the user (S27). In the case where a response is received to register the family ID, on the other hand, the process proceeds to the next step.

The device key Kdev(n) transmitted from the recorder/player 21 to the receiver 11 is recorded in the registered Kdev list in the receiver 11. At the same time, the number of Kdev's of the recorder/players registered in the family and the number of times the family ID of the recorder/player is updated are preferably notified (indicated) to the user (S28). This information may be transmitted to the recorder/player from the receiver and displayed on the recorder/player.

The receiver 11 determines whether or not the number of recorders/players, etc. already registered in the family has reached the limit value (for example, 16 sets) (S31). Specifically, when the limit value is 16, for example, 17 or more recorders/players cannot exist as devices in the same home as the receiver. Preferably, not only the number of sets is managed but also the number of times the ID is set (set number-of-times information). A case in which the limit value of the numbers of times set is managed as 16 is an example. In the case where the number of times the ID is set has already reached a predetermined limit value (S32), the fact that no further registration is possible is notified (indicated) to the user and the registration process is terminated (S33).

Assume that the predetermined limit value is reached, or for example, that the number of the family IDs already overwritten has reached a limit value under a condition that the “overwrite mode” or the like is set. Preferably, a new device number (device key) is set by being overwritten on the device number (device key) of one of the existing family IDs registered. At the same time, the family relation with the device of the family ID overwritten is automatically canceled.

When the predetermined limit value is not reached in step S32, the device number (device key) of the recorder/player is registered in the list of the receiver 11 (S34). In the ID number managing unit, the receiver 11 increases the number of the recorders/players (total number information) registered in the receiver 11 by 1 (S35). At the same time, in the case where the number is managed in terms of the number of times the ID is set, the information on the number of times ID is set is increased by one. Further, in the recorder/player, the number of times the family registration of the recorder/player is updated is increased by one (S36).

The number of the recorders/players in registration is notified (or indicated) to the user (S37). Further, the current number of times the recorders/players are updated (the number of times registered) is notified (or indicated) to the user (S38).

The family ID is transmitted from the receiver 11 to the recorder/player 21 (S39). The recorder/player 21 records the received family ID in the memory 52 or the like (S40). The receiver 11 then transmits the device number registered with a family ID to the broadcast station and the contents distributee using the transmission line (S41).

In the transmission process, the broadcast station and the contents distributee can grasp the range of the devices to which the broadcast contents may be distributed. The upper limit set for the number of Kdev's recorded can prevent the recorder/players from being registered numberlessly as a family unit in one receiver.

In the case where, for example, the recorder/player becomes inoperative due to a malfunction, the number of the recorders/players actually usable as a family member with the receiver is reduced below the number of the recorders/players for which Kdev can be registered in the receiver. To prevent this inconvenience, preferably, a specific message (such as the download information for each carrier or EMM stipulated in ARIB standard) is transmitted to the receiver from the broadcast station, so that the receiver, upon receipt of this message, erases a part or the whole of the recorded Kdev's thereby making possible the registration of a new recorder/player.

In the process described above, the family ID is registered in the recorder/player 21. Nevertheless, this registration process is only an example, and the whole process described above is not always required. Neither the process is executed necessarily in the order of the steps described above.

The number of times the family ID information of the recorder/player 21 is updated, for example, is not necessarily required to be less than a predetermined number. Also, the receiver 11 is not always required to ask the user whether or not the family registration is to be carried out. Further, the process is not necessarily executed in the order of the steps described above.

The number of the family IDs recordable for the recorder/player is normally limited to one (one type). Two (types) or more family IDs recordable, i.e. one recorder/player having two or more family IDs leads to the possibility of a recorder/player being registered as a member of a plurality of families. As long as this situation is permitted by the copyright owner, however, two or more family IDs are registrable for a single recorder/player.

A plurality of devices having the same family ID are defined as the devices in the same home. Therefore, two devices including a receiver and a recorder/player or two different recorder/players connected through the Internet, even though not physically existent in a home, can mutually transmit and receive contents.

In the case where a process of checking the user in the receiver is provided for family ID registration, an illegal attempt of a recorder/player which is not related to the user of the receiver to register the family ID in the receiver is defeated and the registration is prevented. In a similar fashion, the provision of a process for the recorder/player to check the user at the time of family ID registration can prevent the family registration of a receiver which is not related to the recorder/player user.

As described above in detail, by registering the family ID according to this invention by the aforementioned method, the contents can be readily transmitted and copied within the network in a home while at the same time protecting the copyright of the contents of the fee-charging broadcast service, etc.

(Communication Processing Between Receiver and Recorder/Player)

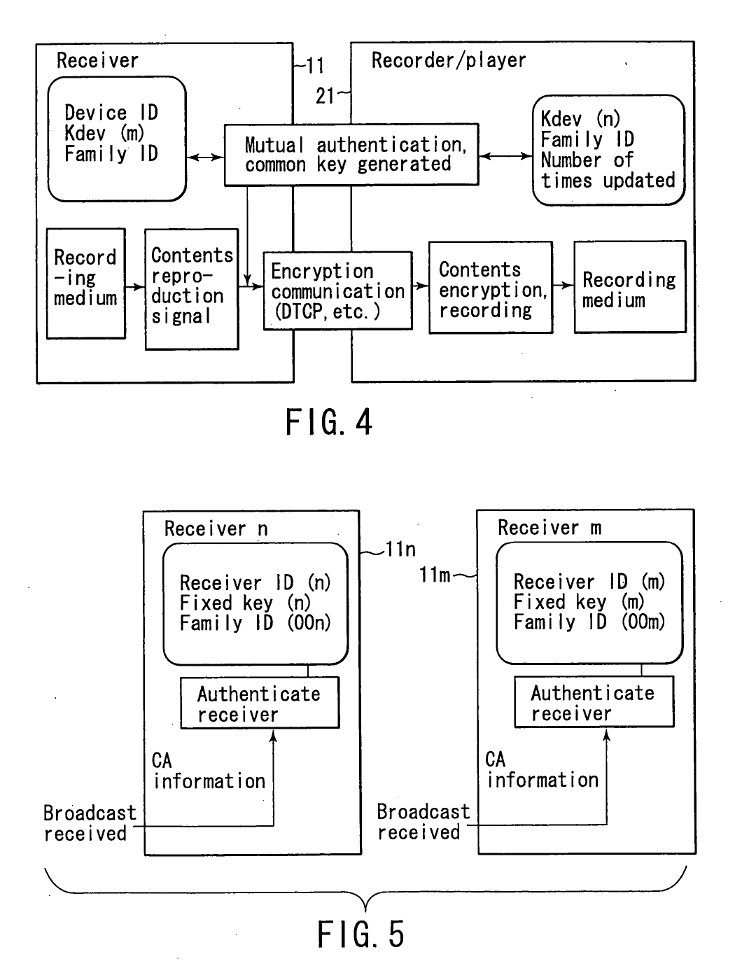

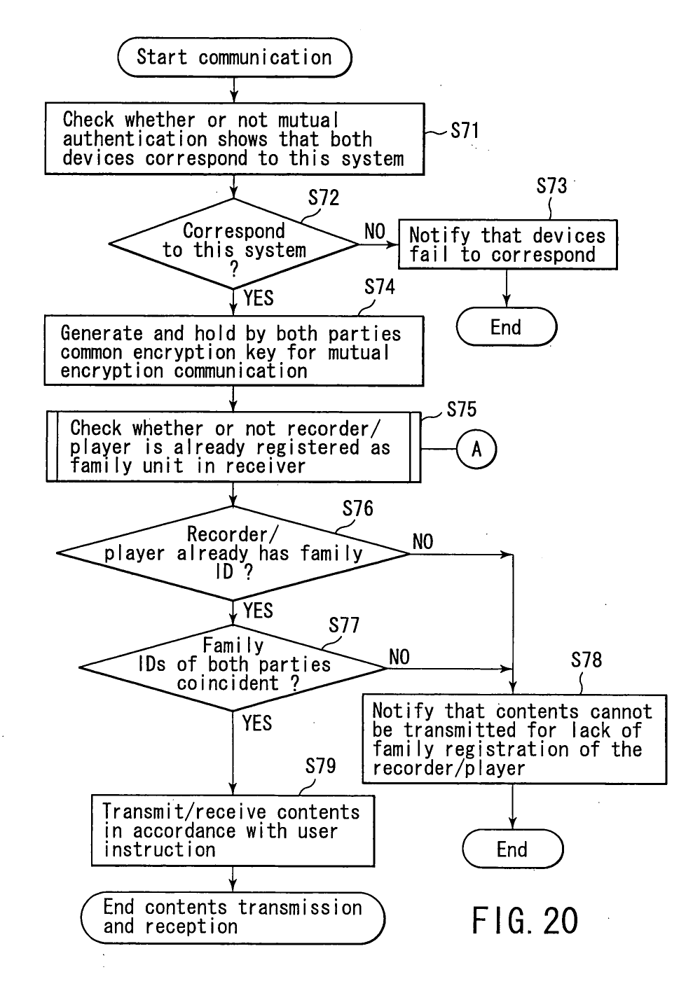

Next, the transmission and reception of the contents, etc. between the receiver and the recorder/player will be explained with reference to the drawings. FIG. 4 is a diagram for explaining an example of the communication processing in the receiving system according to the embodiment of the invention, and FIG. 20 a flowchart showing the communication processing using the family ID in the receiving system according to the embodiment of the invention.

In FIGS. 4 and 20, first, the receiver 11 and the recorder/player 21 carry out challenge and response authentication of each other using random numbers in order to check the correspondence with the CP system (S71). In the absence of correspondence with the CP system (S72), the fact is indicated to the user and the process is terminated (S73). In the case where the receiver 11 and the recorder/player 21 correspond to the CP system, on the other hand, a common key is generated based on random numbers and held by both parties (S74). Thereafter, the communication between the receiver 11 and the recorder/player 21 is carried out by the common key encryption communication using the particular key.

As the next step, it is checked whether or not the family registration of the receiver and the recorder/player 21 has been carried out (S75).

Specifically, as shown in the flowchart of FIG. 19, it is determined whether or not the recorder/player already has a family ID (S75). When the recorder/player already has a family ID, the particular family ID of the recorder/player 21 is transferred to the receiver 11 (S68). The receiver 11 compares the family ID thereof with that of the recorder/player 21 (S69).

Specifically, as long as the recorder/player 21 has a family ID (S76) and the family IDs of the receiver 11 and the recorder/player 21 are coincident with each other (S77), the communication of the contents, etc. is carried out using contents transmission protection means such as DTCP (IEEE1394 or DTCPonIP) and SSL (secure sockets layer) in compliance with a user instruction (S79).

Preferably, at the time of recording the contents in the recorder/player, the contents as related to the family ID or the information indicating the relation between the contents and the family ID is recorded to indicate with which family ID the contents have been acquired. In this way, in the case where the recorder/player is registered again in another receiver and comes to assume a different family ID, it can be identified whether the contents acquired with the original family ID should be delivered to a device of a different family ID.

Unless the family ID is registered or the family ID is coincident, a notification (or an indication) is made to the user that the communication and the transmission/reception of the contents are impossible due to the failure of the recorder/player to register a family ID (S78).

With the steps shown above, the use of the family ID according to this invention makes it possible to copy and move the contents of the communication processing and the fee-charging broadcast service, etc. between the receiver and the recorder/player while at the same time protecting the copyright of the contents.

(Cancellation of Family ID)

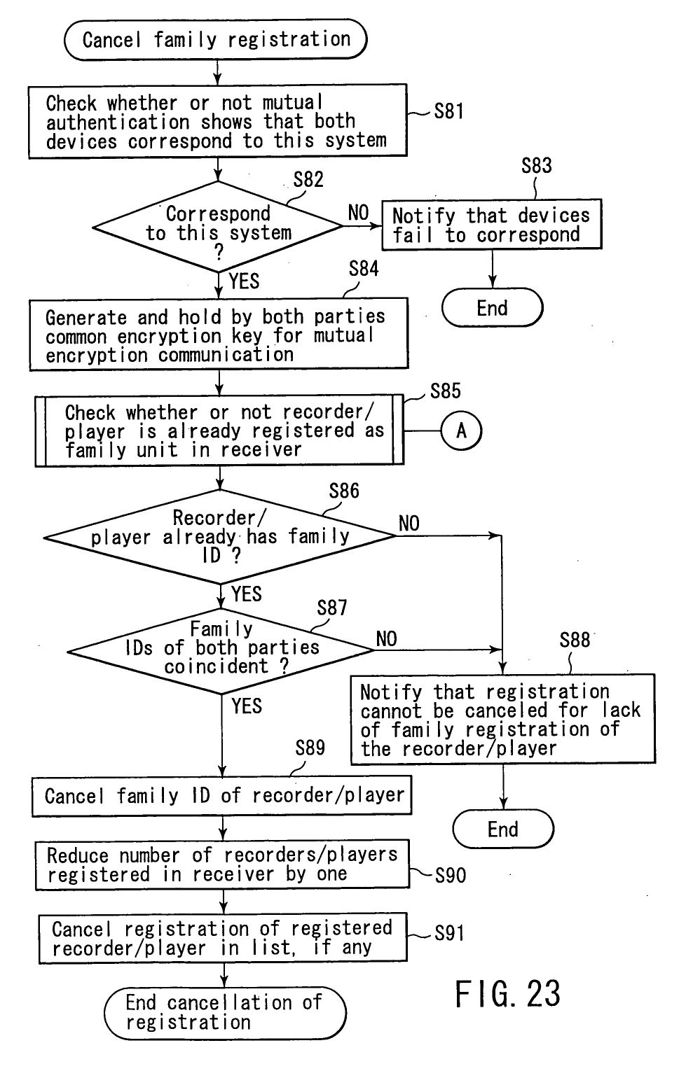

Next, the processing of canceling the family ID according to this invention will be explained with reference to a flowchart. FIG. 23 is a flowchart showing the process of canceling the family ID in the receiving system according to the embodiment of the invention.

In this flowchart, the first step is to conduct the mutual challenge and response authentication using random numbers to check whether or not the receiver 11 and the recorder/player 21 correspond to the CP system (S81). When the recorder/player 21 and the receiver 11 fail to correspond to this system (S82), the fact is indicated to the user and the process is terminated (S83). When the receiver 11 and the recorder/player 21 correspond to the CP system, on the other hand, a common key is generated based on random numbers and held by both parties (S84). The subsequent communication between the receiver 11 and the recorder/player 21 is carried out by the common key encryption communication using this key.

Next, it is checked whether or not the family registration of the receiver 11 and the recorder/player 21 is already finished (S85). Specifically, as shown in the flowchart of FIG. 19, it is determined whether or not the recorder/player 21 already has a family ID (S85), and when the recorder/player 21 already has a family ID, the family ID of the recorder/player 21 is transferred to the receiver 11 (S68). The receiver 11 compares the family ID of the receiver 11 with that of the recorder/player 21 (S69).

Specifically, as long as the recorder/player 21 has a family ID (S86) and the family IDs of the two parties are coincident with each other (S87), the family ID of the recorder/player 21 is erased in compliance with a user instruction (S89), and the number of the recorders/players is reduced by one (S90). In the presence of a list of registered recorders/players, the registration of the particular recorder/player is canceled.

When the family ID is not registered or the family IDs of both parties fail to coincide, on the other hand, a notification or an indication is made to the user to the effect that the lack of family registration of the recorder/player makes it impossible to cancel the family ID (S88).

This process makes it possible to cancel even the family ID registered. <Family registration with two receivers in one home (No. 1)>

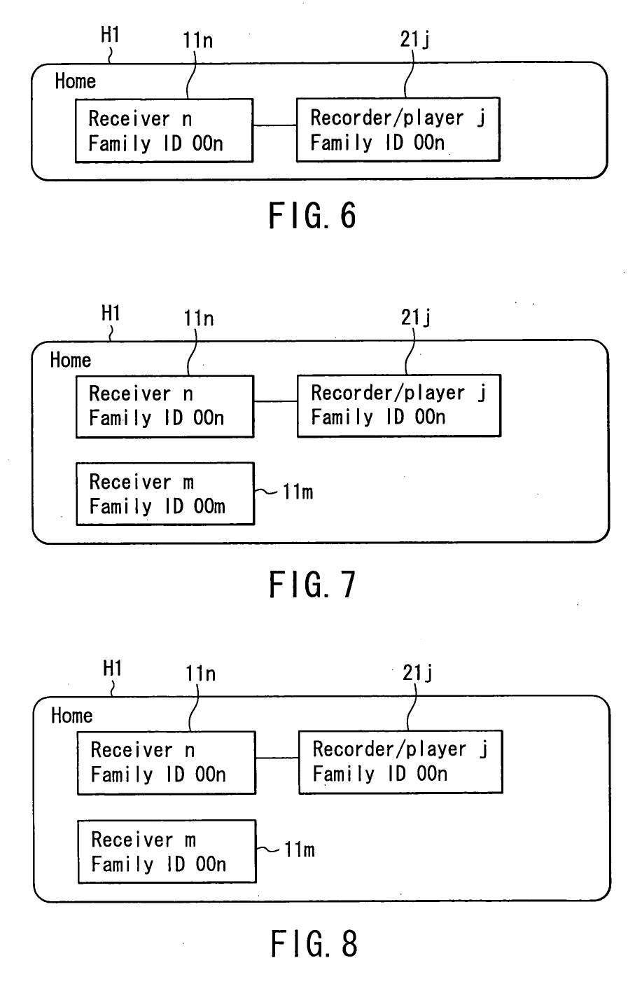

Next, with reference to the drawings, an explanation is given below about a case where one home has a plurality of receivers. FIG. 5 is a diagram for explaining an example of the family ID receiving process for the receiving system according to the embodiment of the invention, and FIGS. 6 to 11 are diagrams for explaining an example of a case where a new receiving apparatus is added to the receiving system according to the embodiment of the invention.

(Reception of Family ID)

One home may have two receivers. These receivers are considered to be associated with the same home in the case where the receivers have the same address under the receiving contract with the broadcast station.

The contents received and recorded in one receiver can be exchanged with one or a plurality of recorders/players registered as family units.

Either the user files an application to the broadcast station for two receivers in the same home or the broadcast station, at the discretion thereof from the terms and conditions of the receiving contract, sends the same-family ID to the respective receivers and notifies each receiver of the family ID of the receivers in the same home, thereby enabling the receivers to recognize the possibility of transmitting and receiving the contents to and from each other.

In FIG. 5, the receiver 11n receives CA (certificate authority) information for the receiver 11n, and receives and records the family ID (00n) of its own. A receiver 11m, on the other hand, receives the CA information for the receiver 11m, and receives and records the family ID (00m) of its own.

As long as the receiver 11n and the receiver 11m are recognized by the broadcast station as the devices associated with the same home, the family ID having the same value is distributed to the two receivers as both CA information for the receiver 11n and the CA information for the receiver 11m. Unless the receiver 11n and the receiver 11m fail to be recognized by the broadcast station as the devices associated with the same home, on the other hand, different family IDs are distributed to the respective receivers using the respective CA information.

First, as shown in FIG. 6, when both the receiver 11n and the recorder/player 21j are existent in a home, the receiver 11n receives the family ID 00n from the broadcast station. The recorder/player 21j is connected to the receiver 11n and has a family ID 00n registered as a family unit.

Thereafter, as shown in FIG. 7, assume that the home H1 buys the receiver 11m anew. At this time point, the broadcast station has yet to recognize the receiver 11m as a device in the home H1 and therefore distributes the family ID 00m to the receiver 11m.

Next, as shown in FIG. 8, the user files an application to the broadcast station for the receiver 11n and the receiver 11m as devices existent in the same home. Then, the broadcast station distributes the family ID 00n to the receiver 11m.

The receiver 11m that has received the family ID 00n comes to have the same family ID as the recorder/player 21j.

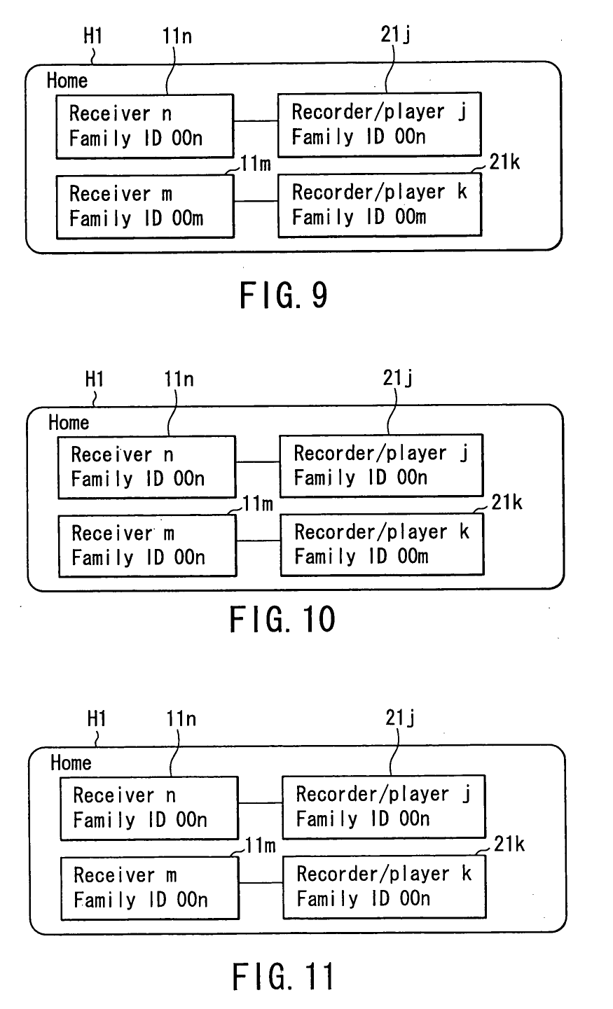

It may happen that as shown in FIG. 9, the user may carry out the family registration of the receiver 11m and the recorder/player 21k before the broadcast station recognizes that the receiver 11n and the receiver 11m are devices in the same home, i.e. while the receiver 11m holds the family ID 00m before receiving the family ID 00n. In that case, the recorder/player 21k receives the family ID 00m.

After that, as shown in FIG. 10, when the receiver 11n and the receiver 11m are recognized by the broadcasting station to belong to the same home as the result of the user filing an application or otherwise, then the family ID 00n is sent to the receiver 11m.

At this time point, as shown in FIG. 11, the recorder/player 21k apparently becomes a device associated with a different home. Therefore, the recorder/player 21k is connected to the recorder 11n or 11m again and recorded as a family unit. In this way, the recorder/player 21k can have the same family ID as the receiver 11n, the receiver 11m and the recorder/player 21j.

At the time point when the recorder/player 21k is connected to the receiver 11m and registered as a family unit, the device key Kdev of the recorder/player 21j is registered in the registered Kdev list of the receiver 11n, and the device key Kdev of the recorder/player 21k in the registered Kdev list of the receiver 11m.

(Transmission and Reception of Contents by Receiver and Recorder/Player)

In the case where the receiver 11n having the same family ID as the recorder/player 21k is connected to the recorder/player 21k and intended to transmit and receive the contents, the authentication is carried out in the following steps.

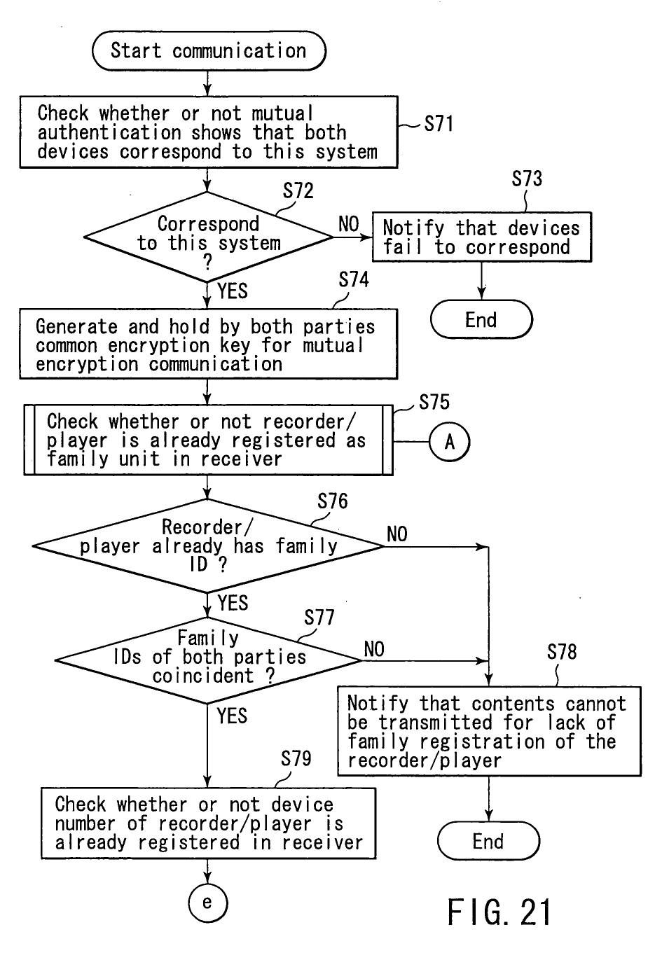

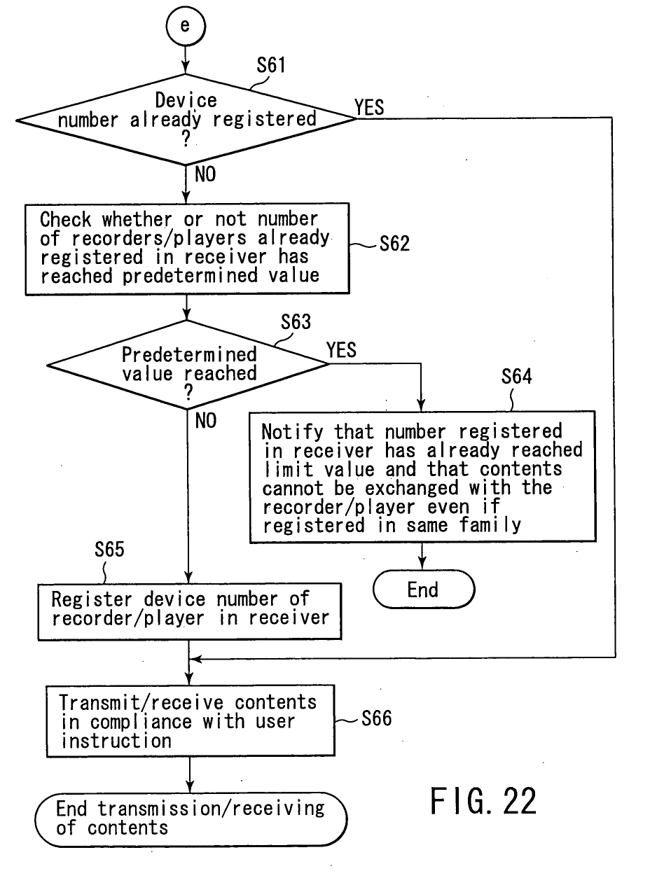

Specifically, in the flowcharts of FIGS. 21 and 22, the first step is for the receiver 11 and the recorder/player 21 to carry out the mutual challenge and response authentication using random numbers to check whether or not the receiver 11 and the recorder/player 21 correspond to the CP system (S51). In the case where the receiver 11 and the recorder/player 21 fail to correspond to the CP system (S52), the fact is indicated to the user and the process is terminated (S53). In the case where the receiver 11 and the recorder/player 21 correspond to the CP system, on the other hand, a common key is generated based on random numbers and held by both parties (S54). After that, the communication between the receiver 11 and the recorder/player 21 is carried out by common key encryption communication using this key.

The next step is to check to see whether or not the family registration of the receiver 11 and the recorder/player 21 has been finished (S55). Specifically, as shown in the flowchart of FIG. 19, it is determined whether or not the recorder/player 21 has already a family ID (S67). When the recorder/player has already a family ID, the family ID of the recorder/player 21 is transferred to the receiver 11 (S68). The receiver 11 compares the family ID of the receiver 11 with that of the recorder/player 21 (S69).

Specifically, when the recorder/player 21 has a family ID (S56) and is yet to be registered as a family unit or the family IDs of both parties are not coincident with each other, the fact that this recorder/player 21 is not registered as a family unit and therefore the communication and exchange of the contents are impossible is notified (indicated) to the user (S57).

When the family IDs of both parties are coincident with each other, on the other hand, the number capable of being registered in the Kdev list is limited in the same manner as the family registration. That is, the recorder/player 21k transmits the device number thereof, i.e. the device key Kdev to the receiver 11n. In the absence of the device Kdev read by the receiver 11n in the registered Kdev list, the receiver 11n records it. In the process, the receiver 11n checks to see whether or not the number of the registered device numbers Kdev already recorded has reached the limit value (S62).

In the case where the number of the registered device numbers Kdev's (total number information) has reached the limit value (S63), the device key Kdev of the recorder/player 21k is not recorded in the receiver 11n, so that even the devices having the same family ID are not recognized as devices associated with the same home. Thus, the contents cannot be transmitted and received as the operation of communication and copying otherwise permitted in the home. Thus, a notification is given (indicated) to the user to the effect that the number registered in the receiver has already reached the limit value, and that the communication processing (transmission and reception of the contents) with this recorder/player is impossible even if the registration is made as the same family as the recorder/player (S64).

When the number of the registered device numbers Kdev's fails to reach the limit value (S63), on the other hand, the receiver 11n records the device number Kdev of the recorder/player 21k in the registered device number Kdev list (S65). Then, the receiver 11n and the recorder/player 21k are recognized as devices in the same family, and therefore can communicate with each other. Further, they can transmit and receive the contents permitted to be copied in the home in compliance with a user instruction (S66).

Preferably, the number of the registered device numbers Kdev's providing the number of the devices registered (total number information) or the number of times the ID is set (set number-of-times information) is used for management. In this case, a limit value is set so that no registration is made in the case where the limit value is reached as in the foregoing case.

The process described above makes possible the communication with the recorder/player constituting a communication apparatus and the transmission and reception of the contents in the case where a plurality of receivers exist in a home. Also, even in the case where there are two or more receivers or two or more recorders/players, they are registered as devices in the same home by distributing the same family ID to them. <Receiving process with two receivers in a home (No. 2)>

(Reception of Family ID and Subfamily ID)

Two receivers may exist in one home. When the two receivers are under a receiving contract with the broadcast station with the same address, the two receivers are considered to exist in the same home.

The contents received and recorded by one of the receivers can be exchanged with one or a plurality of recorders/players registered as family units.

First, as shown in FIG. 6, assume that the receiver 11n and the recorder/player 21j exist in the same home. The receiver 11n receives the family ID 00n from the broadcast station. The recorder/player 21j is connected with the receiver 11n, registered as a family unit and has the family ID 00n.

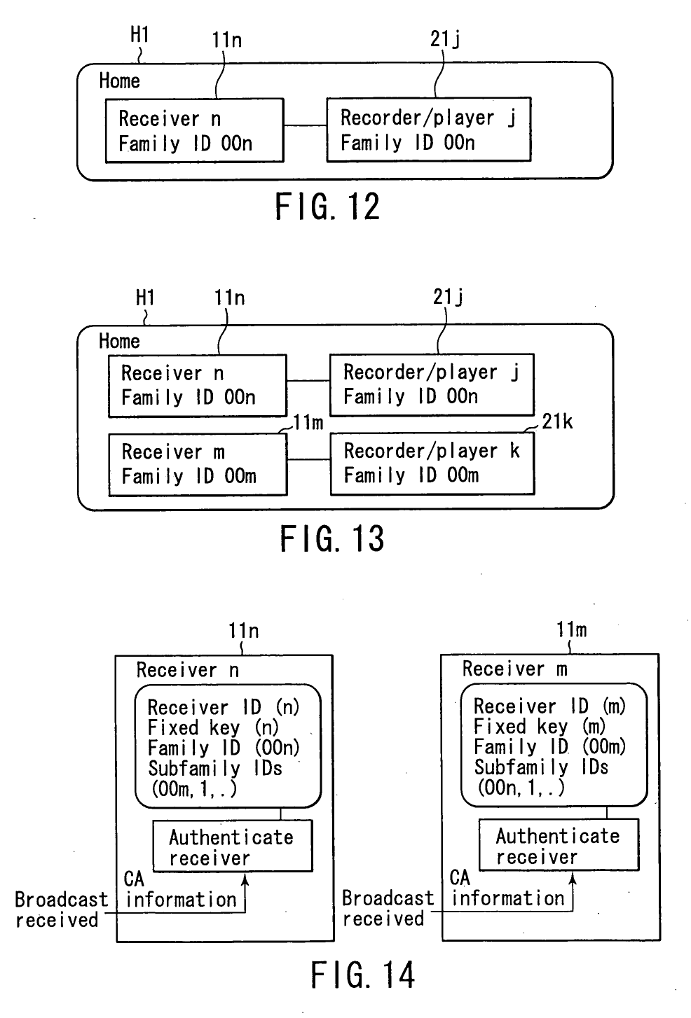

Thereafter, as shown in FIG. 7, the home H1 purchases a receiver 11m anew. At this time point, the broadcast station has yet to recognize the receiver 11m as a device in the home H1, and therefore, as shown in FIG. 13, distributes the family ID 00m to the receiver 11m. The user registers the receiver 11m and the recorder/player 21k as family units. At this time point, the recorder/player 21k has the family ID 00m.

Next, as shown in FIG. 14, the user files an application to the broadcast station for two or more receivers in the home, or the broadcast station, at its own discretion based on the terms and conditions of the contract, sends a family ID of each receiver and a subfamily ID constituting the family ID of the receivers existing in the same home. Upon notification of the subfamily ID, each receiver recognizes the existence of the other receivers in the same home.

Also, in the presence of another receiver 1 in the same home, assume that the broadcast station determines that the particular receiver is a device in the same home based on an application filed by the user. Then, the broadcast station sends also 001 as a subfamily ID.

The receiver 11n receives the CA information for the receiver 11n, and receives and records the family ID (00n) of its own, the family ID (00m) of another receiver 11m existing in the same home, and the family ID (001, etc.) of still another receiver (not shown), if any is existent, as subfamily IDs.

The receiver 11m, on the other hand, receives and records the family ID (00m) of its own, the family ID (00n) of another receiver 11m existing in the same home, and the family ID (001, etc.) of still another receiver (not shown), if existent, as subfamily IDs.

(Transmission of Subfamily ID Between Devices)

Assume that there is a recorder/player assigned a family ID from the receiver 11n. In the case where the receiver 11n is assigned a subfamily ID and the receiver 11n and the particular recorder/player are connected to each other thereafter, then the receiver 11n transmits the subfamily ID to the particular recorder/player, which in turn records the received subfamily ID in the internal memory 52 thereof.

Assume that a given recorder/player is assigned a family ID by the receiver 11m. In the case where the recorder/player is connected with the receiver 11n that has received the subfamily ID, the receiver 11n compares the subfamily ID held therein with the family ID of the recorder/player, and if in coincidence, transmits the family ID of the receiver 11m to the recorder/player, which in turn records the particular family ID as a subfamily ID in the internal memory 52 of the recorder/player.

In any of the above-mentioned cases, the mutual authentication as to whether or not the receiver and the recorder/player correspond to the CP system, the generation of a common key thereby and the encryption communication using the common key are required. The processing for recording Kdev in the receiver (including the comparison with a limited value) is also executed in a similar fashion.

(Contents Transmission and Reception Between Receiver and Recorder/Player in the Same Home)

In the case where the receiver 11n is connected to the recorder/player 21k having the same family ID or the same subfamily ID as the receiver 11n for transmission and reception of the contents, the authentication is carried out following the steps described below.

1. The recorder/player 21k transmits the family ID thereof to the receiver 11n.

2. In the case where the family ID of the recorder/player coincides with the family ID or the subfamily ID of the receiver, the number registrable in the Kdev list is limited in the same manner as in the family registration.

3. The recorder/player 21k transmits the device key Kdev of the recorder/player 21k to the receiver.

4. The receiver 11n checks to see whether or not the key Kdev that has been read exists in the registered Kdev list. In the case where the key Kdev is not registered in the list, the step 5 and subsequent steps are executed. In the case where the key Kdev is registered, on the other hand, the recorder/player 21k is recognized as a device associated with the same home, so that the contents can be transmitted and received as permitted to be copied within the same home.

5. The receiver 11n records the key Kdev that has been read, in the registered Kdev list. At the same time, the receiver 11n checks to see whether or not the number of the registered Kdev's already recorded has reached a limit value.

6. In the case where the number of the registered Kdev's has reached a limited value, the key Kdev of the recorder/player 21k is not recorded in the receiver 11n. In that case, even devices having the same family ID are not recognized to belong to the same home, so that the contents otherwise permitted to be copied cannot be transmitted or received in the home.

7. In the case where the number of the registered Kdev's has yet to reach the limit value, on the other hand, the receiver 11n records the key Kdev of the recorder/player 21k in the registered Kdev list. The recorder/player is then recognized as a device belonging to the same home, so that the contents can be transmitted and received as permitted to be copied within the same home.

Following the steps described above, the transmission/receiving process or the transmission/receiving of the contents between the receiver and the recording player is executed in the same home.

Based on the various embodiments described above, this invention can be implemented by those skilled in the art. Further, it is easy for those skilled in the art to conceive various modifications of the embodiments and various applications of the embodiments without any special inventive ability. Therefore, this invention covers a wide scope without departing from the disclosed principle and the novel features thereof and is not limited to the embodiments described above.

It will thus be understood from the foregoing detailed description that according to this invention, there are provided a receiving apparatus, a communication apparatus, a receiving system and a receiving method for distributing the contents of the fee-charging broadcast service or the like received by the receiving apparatus to the communication apparatus in a home, in which the contents can be freely moved, while at the same time protecting the copyright by registering the ID of the communication apparatus and also limiting the number of the IDs to be registered or the number of times the ID is updated on the part of the communication apparatus.

What is claimed is:

1. A receiving apparatus comprising:
a receiving unit which executes authentication processing with a distributor and receives a contents signal from the distributor in accordance with the result of the authentication;
a registration unit which sets and registers an ID for communication with at least an external communication device in the case where selected one of the number of times the ID is set and the total number of the communication devices for which the ID is set is not more than a predetermined number; and
a communication unit which executes authentication processing with the external device using the ID registered in the registration unit and transmits the contents signal received by the receiving unit to the communication device in accordance with the result of the authentication.

2. A receiving apparatus according to claim 1, wherein the ID set by the registration unit is common identification information set for each of a plurality of eternal devices for communication with the communication unit.

3. A receiving apparatus according to claim 1, wherein the registration unit sets and registers an ID in response to an ID registration instruction using an operating unit of the receiving apparatus.

4. A receiving apparatus according to claim 1, wherein the ID set by the registration unit is assigned by the distributor in accordance with the result of authentication processing executed with the distributor by the receiving unit.

5. A receiving apparatus according to claim 1, wherein the registration unit sets and registers an ID after ascertaining that the number of times the ID is rewritten by the external communication device is not more than a predetermined number.

6. A receiving apparatus according to claim 1, further comprising an ID number management unit which stores selected one of the ID set number-of-times information and the total number of the receiving apparatuses for which an ID is set, and upon setting and registration of the ID of the external communication device by the registration unit, updates selected one of the set number-of-times information and the total number information.

7. A receiving apparatus according to claim 1, further comprising an identification information management unit which stores identification information for identifying the external communication device for which the ID is set, and upon setting and registration of an ID by the registration unit, adds the identification information of the communication device for which the ID is set.

8. A receiving apparatus according to claim 7, wherein, in the case where the identification information management unit accesses the device number of a second communication device having the ID and the device number of the second communication device is not stored at the time of communication with the second communication device after the identification information management unit adds the identification information, the device number of the second communication device is added to the identification information management unit anew and communication is conducted with the second communication device on condition that the device number already stored is not more than a predetermined number.

9. A communication apparatus comprising:
a transmission unit which stores the number-of-times information representing the number of times an ID for communication with an external receiving apparatus has been rewritten in the past, and transmits a predetermined signal to the communication device in the case where the number of times is not more than a predetermined number; and
a receiving unit which executes authentication processing with the receiving apparatus using an ID upon receipt of the ID from the receiving apparatus in accordance with the transmission from the transmission unit, and receives a contents signal from the receiving apparatus in accordance with the result of the authentication.

10. A communication apparatus according to claim 9, wherein the number-of-times information indicating the number of times the ID is rewritten in the past is stored, and upon receipt of a new ID by the receiving unit, the number-of-times information is updated.

11. A communication apparatus according to claim 9, wherein the transmission unit stores the number-of-times information indicating the number of times an ID for communication with an external receiving apparatus is rewritten in the past, and in response to a request, transmits the number-of-times information to the external receiving apparatus.

12. A communication apparatus according to claim 11, wherein the number-of-times information indicating the number of times an ID is rewritten in the past is stored, and upon receipt of a new ID by the receiving unit, the number-of-times information is updated.

13. A receiving system comprising a receiving apparatus which receives a contents signal from a distributor and a communication apparatus supplied with the contents signal from the receiving apparatus, wherein the receiving apparatus has:
a receiving unit which executes authentication processing with the distributor and receives the contents signal from the distributor in accordance with the result of the authentication;
a registration unit which sets and registers an ID for the communication apparatus in the case where the number of times the receiving apparatus has set the ID in the past is not more than a predetermined number; and
a communication unit which executes authentication processing with the communication apparatus using the ID set by the registration unit and transmits the contents signal received by the receiving unit to the communication apparatus in accordance with the result of the authentication, and the communication apparatus has a receiving unit which executes authentication processing with the receiving apparatus using an ID upon receipt of the ID from the receiving apparatus, and receives the contents signal from the receiving apparatus in accordance with the result of the authentication.

14. A receiving system according to claim 13, wherein the registration unit conducts communication with the communication apparatus, and upon receipt of a signal indicating that the number of times the communication apparatus has rewritten the ID is not more than a predetermined number in the case where the number of the IDs set by the receiving apparatus in the past is not more than a predetermined number, sets and registers an ID for the communication apparatus.

15. A receiving system according to claim 13, wherein the registration unit conducts communication with the communication apparatus, acquires from the communication apparatus information on the number of times the ID has been rewritten by the communication apparatus, and sets and registers an ID upon determination that the number of times the ID is rewritten by the communication apparatus is not more than a predetermined number.

16. A receiving system according to claim 13, wherein the ID set by the registration unit is common identification information set for a plurality of external devices for communication with the communication unit.

17. A receiving system according to claim 13, wherein the registration unit sets and registers an ID in response to an instruction to register an ID using an operating unit of the receiving apparatus.

18. A receiving system according to claim 13, wherein the ID set by the registration unit is assigned by the distributor in accordance with the result of authentication processing executed with the distributor by the receiving unit.

19. A receiving method comprising:
receiving a contents signal from a distributor in accordance with the result of authentication processing executed with the distributor by a receiving apparatus;
setting and registering an ID for the communication apparatus in the case where the number of times the receiving apparatus has set the ID in the past is not more than a predetermined number; and
executing authentication processing with the communication apparatus using the registered ID, and transmitting the contents signal to the communication apparatus in accordance with the result of the authentication, wherein the communication apparatus, upon receipt of an ID from the receiving apparatus, executes authentication processing with the receiving apparatus using the ID and receives the contents signal from the receiving apparatus in accordance with the result of the authentication.
